(19) United States
(12) Patent Application Publication
(10) Pub. No.: US 2007/0171580 A1
(43) Pub. Date: Jul. 26, 2007

(54) TUNNEL TYPE MAGNETIC DETECTION ELEMENT IN WHICH FE COMPOSITION OF TOP/BOTTOM SURFACE OF INSULATING BARRIER LAYER IS ADJUSTED AND MANUFACTURING METHOD THEREOF

(75) Inventors: Kazumasa Nishimura, Niigata-ken (JP); Masamichi Saito, Niigata-ken (JP); Masahiko Ishizone, Niigata-ken (JP); Yosuke Ide, Niigata-ken (JP); Ryo Nakabayashi, Niigata-ken (JP); Takuya Seino, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/625,170

(22) Filed: Jan. 19, 2007

(30) Foreign Application Priority Data
Jan. 20, 2006 (JP) 2006-012104

(51) Int. Cl. G11B 5/33; G11B 5/127

(52) U.S. Cl. 360/324.2

(57) ABSTRACT

Described herein is a tunnel type magnetic detection element and a manufacturing method thereof. In the tunnel type magnetic detection element, an enhance layer included in a free magnetic layer (upper magnetic layer) disposed on an insulating barrier layer contacts the insulating barrier layer, which may be made of an oxide such as titanium oxide. Under the insulating barrier layer, a second pinned magnetic layer constituting a pinned magnetic layer is formed in contact with the insulating barrier layer. The Fe composition ratio of the enhance layer is greater than that of the second pinned magnetic layer.

This patent document claims the benefit of Japanese Patent Application No. 2006-012104 filed on Jan. 20, 2006, which is hereby incorporated by reference.

### TECHNICAL FIELD

The present disclosure relates to a tunnel type magnetic detection element for use in a hard disk device or as an MRAM (magnetic resistance memory), and more particularly, to a tunnel type magnetic detection element capable of decreasing a RA (element resistance R X element area A) value and increasing a resistance change ratio (ΔR/R) and a manufacturing method thereof.

### BACKGROUND

In patent documents including JP-A-2001-6130, JP-A-2001-6127, JP-A-2002-164590, JP-A-2005-228998, and JP-A-2004-6589, tunnel type magnetic detection elements are disclosed. The tunnel type magnetic detection element has a stacked layer structure including at least a pinned magnetic layer, a free magnetic layer, and an insulating barrier layer which is interposed between the fixed and free magnetic layers.

The pinned magnetic layer and the free magnetic layer are formed of magnetic materials including FeCo and NiFe (For example, in the 45^{th} paragraph of the patent document JP-A-2001-6130, in the 40^{th} paragraph of the patent document JP-A-2001-6127, and in the 35^{th} paragraph of the patent document JP-A-2002-164590).

However, in the tunnel type magnetic detection element, it is one of the objects to decrease a RA (element resistance R X element area A) value and increase a resistance change ratio (ΔR/R).

As an example, by disposing a magnetic material layer which has a high spin polarization on a side contacting the insulating barrier layer, the resistance change ratio (ΔR/R) is expected to be increased. As an example, a CoFe alloy has a higher spin polarization than a NiFe alloy.

The pinned magnetic layer, as an example, is formed to have a stacked layer ferri-structure which is formed by stacking a first pinned magnetic layer, a second pinned magnetic layer, and a non-magnetic intermediate layer which is interposed between the first and second pinned magnetic layers. The second pinned magnetic layer contacts with the insulating barrier layer.

In addition, in the free magnetic layer, as disclosed in the 67^{th} paragraph of the patent document JP-A-2001-6130, a enhance layer, which has a high spin polarization, is arranged for example in a position contacting the insulating barrier layer (denoted as a tunnel barrier layer 30 in the patent document JP-A-2001-6130) (In the patent document JP-A-2001-6130, it was written that a ferromagnetic thin film layer which is formed of a spin polarization material having high electron conduction is interposed between a ferromagnetic free layer 20 and a tunnel barrier layer 30).

Under the aforementioned structure including the pinned magnetic layer and the free magnetic layer, layers which mainly contribute to the resistance change ratio (ΔR/R) are the second pinned magnetic layer in the pinned magnetic layer and the enhance layer in the free magnetic layer. Generally, the second pinned magnetic layer and the enhance layer are formed of a magnetic material having the same composition. For example, the second pinned magnetic layer and the enhance layer may be formed of Co_{90 at. %}Fe_{10 at. %}. In the 70^{th} paragraph of the patent document JP-A-2001-6130 or the 56^{th} paragraph of the patent document JP-A-2001-6127, it is disclosed that the enhance layer and the pinned magnetic layer are formed of Co.

However, in a general tunnel type magnetic detection element, when the RA value decreases, the resistance change ratio (ΔR/R) also decreases, and accordingly it was difficult to decrease the RA value together with increasing the resistance change ratio (ΔR/R). This fact is verified in an experiment to be described below.

### BRIEF SUMMARY

Provided herein is a tunnel type magnetic detection element that may be capable of decreasing an RA value and increasing a resistance change ratio (ΔR/R), and a manufacturing method thereof.

According to one aspect, the tunnel type magnetic detection element includes a lower magnetic layer, an insulating barrier layer, and an upper ferromagnetic layer sequentially stacked from below. One of the magnetic layers forms at least a portion of a pinned magnetic layer having a fixed magnetization, and the other magnetic layer forms at least a portion of a free magnetic layer having a magnetization that varies in accordance with an external magnetic field. The insulating barrier layer is formed of an oxide, and X, a composition ratio of Fe in the upper magnetic layer, is higher than Y, a composition ratio of Fe in the lower magnetic layer.

According to another aspect, there is provided a method of manufacturing a tunnel type magnetic detection element including the following steps:

(a) forming a lower magnetic layer;

(b) forming a metal layer or a semiconductor layer on the lower magnetic layer;

(c) forming an insulating barrier layer by oxidizing the metal layer or the semiconductor layer; and

(d) forming an upper magnetic layer on the insulating barrier layer, where X, a composition ratio of Fe in the upper magnetic layer, is higher than Y, a composition ratio Y of Fe in a magnetic material of the lower magnetic layer.

### BRIEF DESCRIPTION OF THE DRAWINGS

FIG. 1 is a sectional view of a read head including a tunnel type magnetic resistance effect element according to one embodiment, where the sectional view is taken along a plane parallel to a surface facing a recording medium.

FIG. 2 is a sectional view of a read head including a tunnel type magnetic resistance effect element according to another embodiment, where the sectional view is taken along a plane parallel to a surface facing a recording medium.

FIG. 3 is an enlarged schematic diagram of a part of the tunnel type magnetic detection element in FIG. 1.

FIG. 4 is a schematic diagram showing a crystal structure of titanium oxide.

FIG. 5 is a graph showing the range of Fe composition ratio of the lower and upper magnetic layers.

FIG. 6 is a graph showing the relationship between the Fe composition ratio Y of a enhance layer which is formed on an insulating barrier layer and the RA value.

FIG. 7 is a graph showing the relationship between the Fe composition ratio Y of the enhance layer which is formed on the insulating barrier layer and the resistance change ratio (ΔR/R).

FIG. 8 is a graph showing the Fe composition ratio Y of the enhance layer which is formed on the insulating barrier layer and a bias magnetic field Hpin of a pinned magnetic layer and also the relationship between the Fe composition ratio Y and an Ms·t value of a second pinned magnetic layer which constitutes part of the pinned magnetic layer.

FIG. 9 is a graph showing the relationship between the Fe composition ratio X of the second pinned magnetic layer which is formed on the insulating barrier layer and a RA value.

FIG. 10 is a graph showing the relationship between the Fe composition ratio X of the second pinned magnetic layer which is formed on the insulating barrier layer and a resistance change ratio (ΔR/R) FIG. 11 is a graph showing the relationship between the RA value and the resistance change ratio (ΔR/R) of each one of tunnel type magnetic detection elements according to embodiments 1 and 2 in which the Fe composition ratio of the enhance layer formed on the insulating barrier layer is greater than that of the second pinned magnetic layer formed under the insulating barrier layer and according to a comparison example 1 in which the Fe composition ratios of the enhance layer and the second pinned magnetic layer are the same.

FIG. 12 is a graph showing the relationship between the RA value and the resistance change ratio (ΔR/R) of each one of tunnel type magnetic detection elements according to a comparison example 1 in which the Fe composition ratios of the enhance layer formed on the insulating barrier layer and the second pinned magnetic layer formed under the insulating barrier layer are the same and according to comparison examples 2-1 and 2-2 in which the Fe composition ratios of the enhance layers are smaller than those of the second pinned magnetic layers.

FIG. 13 is a graph showing the relationship between the RA value and the resistance change ratio (ΔR/R) of each one of multiple tunnel type magnetic detection elements in which the Fe composition ratios of the second pinned magnetic layers are different, especially by the group base on the crystal structures.

FIG. 14 is a graph showing the resistance change ratio (ΔR/R) of each one of tunnel type magnetic detection elements according to embodiments 3 and 4 of the present invention in which the Fe composition ratio of the enhance layer formed on the insulating barrier layer is greater than that of the second pinned magnetic layer formed under the insulating barrier layer (where the Ni composition ratios of the soft magnetic layers are different between the embodiments 3 and 4 and according to a comparison example 3 in which the Fe composition ratios of the enhance layer and the second pinned magnetic layer are the same.

FIG. 15 is a graph showing magnitudes of magnetostriction of the embodiments 3 and 4 and the comparison example 3.

### DETAILED DESCRIPTION

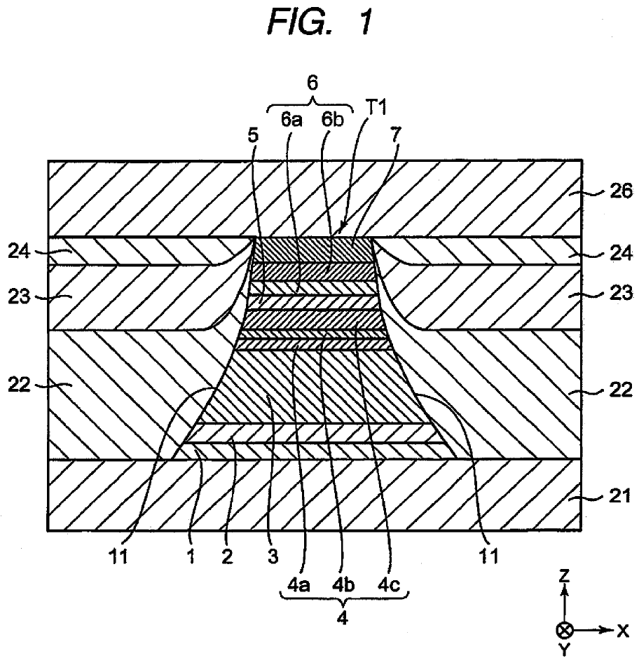

FIG. 1 is a sectional view of a read head including a tunnel type magnetic resistance effect element according to one embodiment taken along a plane parallel to a surface facing a recording medium.

The tunnel type magnetic resistance effect element is disposed, for example, on an end portion of a trailing side of a levitation type slider included in a hard disk device to detect a recorded magnetic field on a hard disk or the like. In the figure, a direction X is a track width direction, a direction Y is a direction of a leakage magnetic field from a magnetic recording medium (height direction), and a direction Z is a moving direction of a magnetic recording medium including a hard disk and a stacking direction of each layer of the tunnel type magnetic resistance effect element.

A bottom shield layer 21 formed of a NiFe alloy, for example, is formed in a lowest position in FIG. 1. On the bottom shield layer 21, a stacked layer body Ti is formed. In addition, the tunnel type magnetic resistance effect element includes a lower insulating layer 22, a hard bias layer, and an upper insulating layer 24 which are formed on both sides of the stacked layer body T1 in a track widthwise direction (the direction X) along with the stacked layer body T1.

The lowest layer of the stacked layer body T1 is a base layer 1 which may be formed of a non-magnetic material including one or more elements selected from among Ta, Hf, Nb, Zr, Ti, Mo, and W. On the base layer 1, a seed layer 2 is formed. The seed layer 2 is formed of NiFeCr or Cr.

An anti-ferromagnetic layer 3 which is formed on the seed layer 2 is formed of an anti-ferromagnetic material containing an element α (where α is one or more elements selected from among Pt, Pd, Ir, Rh, Ru, and Os) and Mn or an anti-ferromagnetic material containing elements α, \acute{α} (where \acute{α} is one or more elements selected from among Ne, Ar, Kr, Xe, Be, B, C, N, Mg, Al, Si, P, Ti, V, Cr, Fe, Co, Ni, Cu, Zn, Ga, Ge, Zr, Nbr Mo, Ag, Cd, Sn, Hf, Ta, W, Re, Au, Pb, and rare-earth elements), and Mn. For example, the anti-ferromagnetic layer 3 may be formed of IrMn or PtMn.

On the anti-ferromagnetic layer 3, a pinned magnetic layer 4 is formed. The pinned magnetic layer 4 has a stacked layer ferri-structure in which a first pinned magnetic layer 4a, a non-magnetic intermediate layer 4b, and a second pinned magnetic layer 4c are stacked sequentially from the bottom. The magnetization directions of the first and second pinned magnetic layers 4a and 4c become anti-parallel to each other due to an exchange coupled magnetic field on a boundary surface with the anti-ferromagnetic layer 3 and an anti-ferromagnetic exchange coupled magnetic field (RKKY interaction) through the non-magnetic intermediate layer 4b. This is called a stacked layer ferri-structure. By using the stacked layer ferri-structure, magnetization of the pinned magnetic layer 4 may be in a stable state, and an apparent exchange coupled magnetic field generated from a boundary surface between the pinned magnetic layer 4 and the anti-ferromagnetic layer 3 may increase.

The first pinned magnetic layer 4a may be formed of a ferromagnetic material such as CoFe, NiFe, or CoFeNi. The non-magnetic intermediate layer 4b may be formed of a non-magnetic conductive material such as Ru, Rh, Ir, Cr, Re, or Cu. The second pinned magnetic layer 4c will be described later.

An insulating barrier layer 5 which is formed on the pinned magnetic layer 4 may be formed of an insulating oxide. The insulating barrier layer 5 may be formed of a titanium oxide (Ti—O), preferably. For example, the insulating barrier layer 5 may be formed of titanium dioxide (TiO₂).

On the insulating barrier layer 5, a free magnetic layer 6 is formed. The free magnetic layer 6 includes a soft magnetic layer 6b formed of a magnetic material such as a NiFe alloy and an enhance layer 6a formed between the soft magnetic layer 6b and the insulating barrier layer 5. The soft magnetic layer 6b may be formed of a magnetic material which has a superior soft magnetic property, preferably. The enhance layer 6a may be formed of a magnetic material which has a higher spin polarization than that of the soft magnetic layer 6b.

A track width Tw is determined as a width value of the free magnetic layer 6 in a track widthwise direction (direction X).

On the free magnetic layer 6, a protective layer 7, which is formed of a non-magnetic conductive material such as Ta, is formed.

As shown in FIG. 1, sides 11 and 11 of the stacked layer body Ti in a track widthwise direction (direction X) are formed as inclined surfaces in which a width between the sides 11 and 11 in the track widthwise direction gradually decreases upward from the bottom.

As shown in FIG. 1r the lower insulating layer 22 is formed on portions of the lower shield layer 21 extending out from under the stacked layer body T1 and on the side portions 11 of the stacked layer body T1. In addition, on the lower insulating layer 22, the hard bias layer 23 is formed, and on the hard bias layer 23, the upper insulating layer 24 is formed.

Between the lower insulating layer 22 and the hard bias layer 23, a bias base layer (not shown) may be formed. The bias base layer may be formed of, for example, Cr, W, or Ti.

The insulating layers 22 and 24 are formed of insulating materials such as Al₂O₃ or SiO₂. In order to suppress a divided flow of a current which flows in a direction perpendicular to boundary surfaces of layers in the stacked layer body T1 into the sides of the stacked layer body T1 in the track widthwise direction, the top and bottom of the hard bias layer 23 is insulated. The hard bias layer 23 may be formed of, for example, a Co—Pt (cobalt-platinum) alloy, a Co—Cr—Pt (cobalt-chrome-platinum), or the like.

On the stacked layer body T1 and the upper insulating layer 24, an upper shield layer 26, which may be formed of a NiFe alloy or the like, is formed.

In the embodiment shown in FIG. 1, the lower shield layer 21 and the upper shield layer 26 serve as electrode layers of the stacked layer body T1, and a current flows in a direction perpendicular to surfaces of the layers of the stacked layer body T1 (direction parallel to the direction Z).

The free magnetic layer 6 is magnetized in a direction parallel to the track widthwise direction (direction X) by a bias magnetic field from the hard bias layer 23. The first and second pinned magnetic layers 4a and 4c which constitute part of the pinned magnetic layer 4 are magnetized in a direction parallel to the height direction (direction Y). Since the pinned magnetic layer 4 has a stacked layer ferri-structure, the first and second magnetic layers 4a and 4c are magnetized as anti-parallel, respectively. While the magnetization of the pinned magnetic layer 4 is fixed or pinned (the magnetization is not changed by an external magnetic field), the magnetization of the free magnetic layer 6 may be changed by an external magnetic field.

If the magnetization of the free magnetic layer 6 is changed by an external magnetic field when magnetizations between the second pinned magnetic layer 4c and the free magnetic layer 6 are anti-parallel, it becomes difficult for a tunnel current to flow through the insulating barrier layer 5 which is disposed between the second pinned magnetic layer 4c and the free magnetic layer 6. Accordingly, in this case it is possible to maximize a resistance. To the contrary, when the magnetizations between the second pinned magnetic layer 4c and the free magnetic layer 6 are parallel, it becomes easy for the tunnel current to flow. Accordingly, the resistance may be minimized.

Using this principle, a leakage magnetic field from a recording medium may be detected as a change in voltage when an external magnetic field alters the magnetization of the free magnetic layer 6 and thus the electrical resistance of the device.

A technical aspect of the embodiment shown in FIG. 1 will now be described. The second pinned magnetic layer (lower magnetic layer) 4c constituting the pinned magnetic layer 4 shown in FIG. 1 is formed to contact the bottom surface of the insulating barrier layer 5. The enhance layer (upper magnetic layer) 6a constituting the free magnetic layer (upper magnetic layer) 6 is formed to contact the top surface of the insulating barrier layer 5. The second pinned magnetic layer 4c, the insulating barrier layer 5, and the enhance layer 6a are configured to affect the resistance change ratio (ΔR/R).

In the embodiment, the second pinned magnetic layer 4c which is formed under the insulating barrier layer 5 is formed of Co_{100-X}Fe_{X} (where X is in units of at. %). In addition, the enhance layer 6a, which is formed on the insulating barrier layer, is formed of Co_{100-Y}Fe_{Y} (where Y is in units of at. %). The thickness of the second pinned magnetic layer 4c is from about 10 to 50 Å, and the thickness of the enhance layer 6a is from about 5 to 20 Å.

An Fe composition ratio (concentration) Y of the enhance layer 6a is preferably greater than a Fe composition ratio (concentration) X of the second pinned magnetic layer 4c.

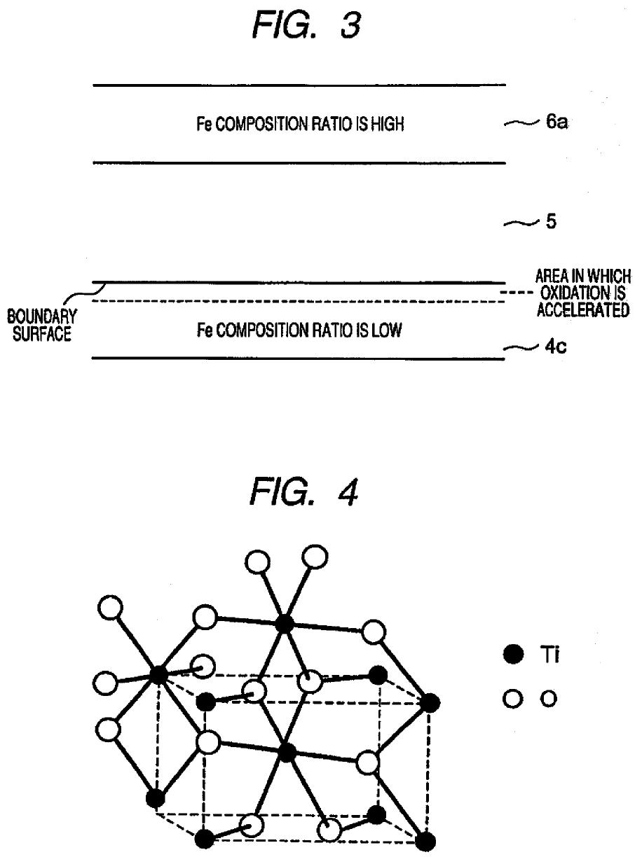

An area around the boundary surface of the second pinned magnetic layer 4c with the insulating barrier layer 5, as shown in FIG. 3, is in an oxidized state. This is mainly because the oxidation of the insulating barrier layer 5 has an effect on the second pinned magnetic layer 4c.

As shown in FIG. 3, when the second pinned magnetic layer 4c which has a low Fe composition ratio exists under the insulating barrier layer 5 and the enhance layer 6a which has a high Fe composition ratio exists on the insulating barrier layer 5, it is thought that oxygen around the boundary surface of the second pinned magnetic layer 4c is attracted toward the enhance layer 6a (that is, around the boundary of the second pinned magnetic layer 4c is deoxidized) and that the amount of the oxygen around the boundary surface of the second pinned magnetic layer 4c is decreased. As a result, the spin polarization of the second pinned magnetic layer 4c is improved. The enhance layer 6a is originally in a state in which a spin polarization is high. Since the enhance layer 6a is formed on the insulating barrier layer 5, the effect of oxidation on the enhance layer 6a is smaller than that on the second pinned magnetic layer 4c. Accordingly, the enhance layer 6a can maintain a high spin polarization.

As described above, in this embodiment, the spin polarizations of the second pinned magnetic layer 4c and the enhance layer 6a can improve appropriately to make it possible to decrease the RA value together with increasing the resistance change ratio (ΔR/R).

For example, when Fe composition ratios of the second pinned magnetic layer 4c and the enhance layer 6a are the same or an Fe composition ratio of the second pinned magnetic layer 4c is greater than that of the enhance layer 6a, it may not be possible to decrease the RA value together with decreasing the resistance change ratio (ΔR/R), compared with the present embodiment, as is shown by an experiment to be described later. It is thought that the reason relates to a force attracting oxygen around the boundary surface of the second pinned magnetic layer 4c, which is formed under the insulating barrier layer 5, toward the enhance layer 6a, which is formed on the insulating barrier layer 5. The force may be weaker or may not exist compared to the above-described embodiment and consequently it may not be possible to improve both spin polarizations of the second pinned magnetic field 4c and the enhance layer 6a appropriately. In addition, when the Fe composition ratio is increased, oxidation occurs more readily. Accordingly, when the Fe composition ratio of the second pinned magnetic layer 4c, which is under the insulating barrier layer 5, is set to be too high, the effect of the oxidation becomes too strong, and accordingly, the spin polarization of the second pinned magnetic layer 4c may not be effectively improved, although some of the oxygen may be attracted toward the enhance layer 6a. As described above, by configuring the Fe composition ratio Y of the enhance layer 6a, which is formed on the insulating barrier layer 5 to be greater than the Fe composition ratio of the second pinned magnetic layer 4c, which is formed under the insulating barrier layer 5, it becomes possible to decrease the RA value together with increasing the resistance change ratio (ΔR/R) appropriately.

The insulating barrier layer 5 may be formed of titanium oxide (Ti—O), preferably. The titanium oxide has a strong force for attracting oxygen. When compared with a case where the insulating barrier layer 5 is formed of aluminum oxide (Al—O), as an example, it is easier to attract the oxygen of the second pinned magnetic layer 4c toward the enhance layer 6a when the insulating barrier layer is formed of titanium oxide (e.g., titanium dioxide). Accordingly, it may be possible to improve the spin polarization of the second magnetic layer 4c appropriately when the insulating barrier layer 5 is formed of titanium oxide (Ti—O), and thus the resistance change ratio (ΔR/R) may be increased effectively. Alternatively, magnesium oxide (Mg—O), Ni—Or Gd—O, Ta—O, Mo—O, Si—O, or W—O may be used for the insulating barrier layer 5 instead of the titanium oxide.

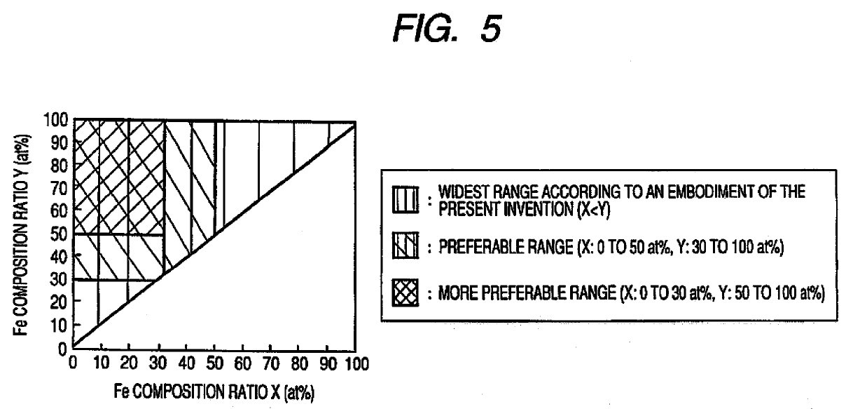

In this embodiment the Fe composition ratio X of the enhance layer 6a is desirably set to be greater than the Fe composition ratio Y of the second pinned magnetic layer 4c, as described above; however, the second pinned magnetic layer 4c which is formed under the insulating barrier layer 5 may be formed of Co_{100-X}Fe_{X}, and the Fe composition ratio X may be in the range of 0 at. % to about 50 at. %, preferably, as shown in FIG. 5. The Fe composition ratio X may be in the range of 0 at. % to about 30 at. %, more preferably. Even more preferably, the Fe composition ratio X may be in the range of 0 at. % to about 20 at. %. In other words, the second pinned magnetic layer 4c is formed of Co or a CoFe alloy having a low Fe composition ratio X. In addition, by adjusting the Fe composition ratio X in the range of 0 at. % to about 20 at. %, it is preferable that the crystal structure of the second pinned magnetic layer 4c have a face centered cubic (fcc) structure. Forming the second magnetic layer 4c as a face centered cubic structure will be described later.

By adjusting the composition of the second pinned magnetic layer 4c, which is formed under the insulating barrier layer 5 as described above, it becomes possible to decrease the RA value together with increasing the resistance change ratio (ΔR/R) appropriately according to a result of an experiment to be described later.

The enhance layer 6a, which is formed on the insulating barrier layer 5, may be formed of Co_{100-Y}Fe_{Y}, and the Fe composition ratio Y, as shown in FIG. 5, may be in the range of from about 30 at. % to 100 at. %, preferably. The Fe composition ratio Y may be in the. range of from about 50 at. % to 100 at. %, more preferably. Even more preferably, the Fe composition ratio Y may be in the range of from about 70 at. % to 100 at. %. In other words, the enhance layer is formed of Fe or a CoFe alloy having a high Fe composition ratio Y. In addition, the enhance layer 6a which has the composition ratio within the range described above preferably has a body centered cubic (bcc) structure.

By adjusting the composition of the enhance layer 6a as described above, it is possible to decrease the RA value and increase the resistance change ratio (ΔR/R), appropriately according to a result of an experiment to be described later.

The crystal structure of each layer will now be described. It is preferable that at least a part of the second pinned magnetic layer 4c which is formed under the insulating barrier layer 5 has a face centered cubic (fcc) structure and that crystal planes equivalent to a (111) plane of the fcc structure may be aligned parallel to a layer surface (X-Y surface). Included among the equivalent crystal planes which are part of the {111} family of crystallographic planes are (111), (−111), (1-11), (11-1) , (−1-11), (−11-1), (1-1-1), and (−1-1-1) planes, as represented by their Miller indices.

Since the (111) plane of the face centered cubic structure has a highest atomic packing density, oxygen may not readily penetrate the second pinned magnetic layer 4c, and accordingly oxidation of the second pinned magnetic layer 4c may be prevented effectively. In order to form the second pinned magnetic layer 4c as a face centered cubic structure, the Fe composition ratio X may be adjusted in the range of from 0 at. % to about 20 at. % preferably when the second pinned magnetic layer 4c is formed of Co_{111-X}Fe_{X}. In addition, since the oxide formation energy of Fe is smaller than that of Co, the higher the Fe composition ratio X becomes, the more easily the oxidation occurs. And accordingly, by lowering the Fe composition ratio X, oxidation of the second pinned magnetic layer 4c can be suppressed appropriately. As described above, by forming the second pinned magnetic layer 4c as a face centered cubic (fcc) structure in which crystal planes equivalent to the (111) plane of the fcc structure are aligned parallel to a layer surface, oxidation of the second pinned magnetic layer 4c may be suppressed appropriately, and accordingly it is possible to improve the spin polarization of the second pinned magnetic layer 4c appropriately.

Next, although the insulating barrier layer 5 may have an amorphous structure, preferably at least a part of the insulating barrier layer 5 may be one of a body centered cubic (bcc) structure, a body centered tetragonal structure, or a rutile structure. When the insulating barrier layer 5 is formed of Ti—O, Sn—O, Pd—O, V—O, Nb—O, or Mn—O, the insulating barrier layer 5 may be formed to have the rutile structure.

Next, it is preferable that at least a part of the enhance layer 6a may have a body centered cubic (bcc) structure and that crystal planes equivalent to a (110) plane of the bcc structure may be aligned parallel to a layer surface (X-Y surface). Included among the equivalent crystal planes which are part of the {110} family of crystallographic planes are (110), (−110), (1-10), (−1-10), (101), (−101), (10-1), (−10-1), (011), (0-11), (01-1), and (0-1-1) planes, as represented by their Miller indices.

When the insulating barrier layer 5 is formed as one of the body centered cubic (bcc) structure, the body centered tetragonal structure, or the rutile structure, and if the enhance layer 6a is formed as the body centered cubic structure, lattice matching on a boundary surface between the insulating barrier layer 5 and the enhance layer 6a is improved to enhance the crystallinity of the enhance layer 6a, and accordingly, it is possible to improve the spin polarization of the enhance layer 6a appropriately.

As an example, when the insulating barrier layer 5 is formed of titanium oxide, it is thought that the crystal structure of the insulating barrier layer 5 is predominantly the rutile structure, which has a high thermal stability. The rutile structure is as shown in FIG. 4. As shown in FIG. 4, since Ti has a body centered tetragonal structure, when the enhance layer 6a having a body centered cubic structure is formed on the insulating barrier layer 5 having the rutile structure, it is possible to improve the lattice matching on a boundary surface between the insulating barrier layer 5 and the enhance layer 6a appropriately. In order to form the enhance layer 6a as the body centered cubic structure, the Fe composition ratio Y may be adjusted in the range of from about 30 at. % to 100 at. % when the enhance layer Ga is formed of Co_{100-Y}Fe_{Y}. In addition, as described above, it is preferable to control the Fe composition ratio Y in the range of from about 50 at. % to 100 at. %, and more preferably, in the range of from about 70 at. % to 100 at. %, for decreasing the RA value together with increasing the resistance change ratio (ΔR/R) more effectively.

Next, the soft magnetic layer 6b constituting the free magnetic layer 6 may be preferably formed of a NiFe alloy to improve soft magnetic property of the soft magnetic layer 6b. As an experiment to be described later indicates, when the enhance layer 6a formed on the insulating barrier layer 5 is formed of Co_{50 at %}Fe_{50 at. %}, and when the soft magnetic layer 6b is formed of Ni_{81.5 at. %}Fe_{18.5 at. %}, as an example, the resistance change ratio (ΔR/R) can improve, compared with a case where the enhance layer 6a is formed of Co_{90 at. %}Fe_{10 at. %} and the soft magnetic layer 6b is formed of Ni_{81.5 at. %}Fe_{18.5 at. %}. However, there is a problem in that an absolute value of magnetostriction λ of the free magnetic layer 6 increases. Accordingly, it is preferable to appropriately select the material of the soft magnetic layer 6b for decreasing an absolute value of the magnetostriction λ of the free magnetic layer 6. Since the enhance layer 6a has a positive magnetostriction when the Fe composition ratio is increased, it is preferable to select a soft magnetic material having a negative magnetostriction for the soft magnetic layer 6b.

When the enhance layer 6a is formed of a CoFe alloy and the soft magnetic layer 6b is formed of Ni_{Z}Fe_{100-Z}, the Ni composition ratio Z may be greater than about 81.5 at. % and equal to or smaller than 100 at. % preferably. By adjusting the Ni composition ratio as described above, an absolute value of the magnetostriction of the free magnetic layer 6 can be decreased.

Alternatively, a structure in which a soft magnetic layer formed of Ni_{Z}Fe_{100-Z} having the Ni composition ratio Z greater than about 81.5 at. % and equal to or less than 100 at. % is interposed between a soft magnetic layer 6b having a general composition and the enhance layer 6a may be used.

In FIG. 1, the entire second pinned magnetic layer 4c which is formed under the insulating barrier layer 5 may be formed as a lower magnetic layer according to this embodiment. Alternatively, the second pinned magnetic layer 4c may have a stacked layer structure of magnetic layers and at least one magnetic layer among the magnetic layers which contacts the insulating barrier layer 5 may be formed as the lower magnetic layer 4, according to the present embodiment. And also, the structure of the pinned magnetic layer 4 is not limited to the stacked layer ferri-structure shown in FIG. 1 and may include a single layer structure of a magnetic layer or a stacked structure of magnetic layers. In this case, the lower magnetic layer according to the present embodiment may be provided as the entire pinned magnetic layer 4 or a part thereof (at least a magnetic layer which contacts the insulation barrier layer 5).

In FIG. 1, although the entire enhance layer 6a, which is formed on the insulating barrier layer 5, is formed as an upper magnetic layer according to the present embodiment, the enhance layer 6a may be formed as a stacked layer structure of magnetic layers, and at least a magnetic layer which contacts the insulating barrier layer 5 may be formed as an upper magnetic layer according to one embodiment. Alternatively, the enhance layer 6a may not be included in the free magnetic layer 6, and the structure of the free magnetic layer is not limited to a structure shown in FIG. 1. In addition, the enhance layer 6a preferably has a higher spin polarization than that of the soft magnetic layer 6b and the enhance layer may prevent at least one element (Ni when formed of NiFe) which constitutes the soft magnetic layer 6b from penetrating into the insulating barrier layer 5. The enhance layer 6a may not be formed. In conclusion, the entire or a part of the free magnetic layer 6 (at least a magnetic layer which contacts the insulating barrier layer 5) is to be formed in the upper magnetic layer according to the present embodiment.

In the embodiment shown in FIG. 1, the pinned magnetic layer 4 is formed under the insulating barrier layer 5, and the free magnetic layer 6 is formed on the insulating barrier layer 5. However, in a case where the free magnetic layer 6 is formed under the insulating barrier layer 5, and the pinned magnetic layer 4 is formed on the insulating barrier layer 5, more specifically, when a soft magnetic layer 6b, an enhance layer 6a, an insulating barrier layer 5, a second pinned magnetic layer 4c, a non-magnetic intermediate layer 4b, and a first pinned magnetic layer 4a are sequentially stacked from the bottom, the Fe composition ratio of the second pinned magnetic layer 4c (upper magnetic layer) may be higher than that of the enhance layer 6a (lower magnetic layer). In other words, when a structure which has a reverse structure of FIG. 1 is used, the enhance layer 6a which is formed under the insulating barrier layer 5 may have the same composition or crystal structure as the second pinned magnetic layer 4c shown in FIG. 1, and the second pinned magnetic layer 4c which is formed on the insulating barrier layer 5 may have the same composition or crystal structure as the enhance layer 6a shown in FIG. 1.

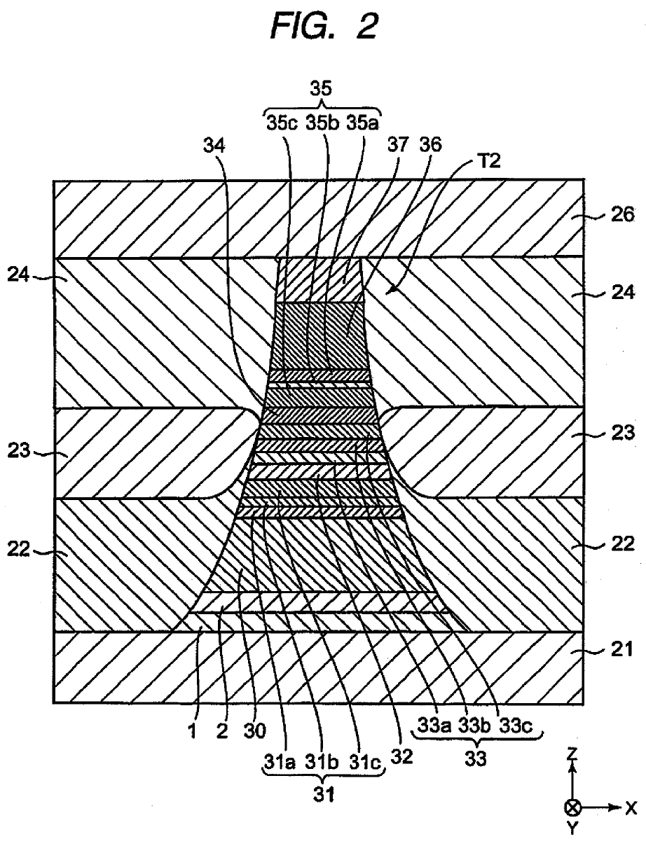

FIG. 2 is a sectional view of a read head including a tunnel type magnetic resistance effect element according to a second embodiment taken along a plane parallel to a surface which faces a recording medium. A layer having a same reference numeral as in FIG. 1 represents a same layer as in FIG. 1.

In FIG. 2, the tunnel type magnetic detection element is formed as a dual type. In other words, the stacked layer body T2 constructing the tunnel type magnetic detection element has a structure in which a base layer 1, a seed layer 2, a lower anti-ferromagnetic layer 30, a lower pinned magnetic layer 31, a lower insulating barrier layer 32, a free magnetic layer 33, an upper insulating barrier layer 34, an upper pinned magnetic layer 35, an upper anti-ferromagnetic layer 36, and a protection layer 37 are stacked sequentially from the bottom.

The lower pinned magnetic layer 31 has a stacked layer ferri-structure in which a lower first pinned magnetic layer 31a, a lower non-magnetic intermediate layer 31b, and a lower second pinned magnetic layer 31c are sequentially stacked from the bottom.

The upper pinned magnetic layer 35 has a stacked layer ferri-structure in which an upper second pinned magnetic layer 35c, an upper non-magnetic intermediate layer 35b, and an upper first pinned magnetic layer 35a are sequentially stacked from the bottom.

The free magnetic layer 33 has a stacked layer structure in which an enhance layer 33a, a soft magnetic layer 33b, and an enhance layer 33c are sequentially stacked.

In the embodiment shown in FIG. 2, two insulating barrier layers 32 and 34 are formed. Accordingly, the Fe composition ratios of magnetic layers which are formed on or under the insulating barrier layers 32 and 34 may be adjusted appropriately.

When the Fe composition ratios of the enhance layer 33a (upper magnetic layer), which is a lowest layer of the free magnetic layer 33 formed on the lower insulating barrier layer 32, and the lower second pinned magnetic layer 33c (lower magnetic layer), which is formed under the lower insulating barrier layer 32, are compared with each other, the Fe composition ratio of the enhance layer 33a may be higher than that of the lower second fixed magnet layer 31c. In addition, when the Fe composition ratios of the upper second pinned magnetic layer 35c (upper magnetic layer), which is formed on the upper insulating barrier layer 34, and the enhance layer 33c (lower magnetic layer), which is a highest layer of the free magnetic layer 33 formed under the upper insulating barrier layer 34, are compared with each other, the Fe composition ratio of the upper second pinned magnetic layer 33c may be higher than that of the enhance layer 33c. The lower insulating barrier layer 32 and the upper insulating barrier layer 34 are formed of insulating oxide materials such as titanium oxide.

By using the aforementioned structure, it is possible to decrease the RA value and increase the resistance change ratio (ΔR/R).

The enhance layer 33a and the upper second pinned magnetic layer 35c which are formed on the insulating barrier layers 32 and 34, respectively, shown in FIG. 2, may have the same composition and crystal structure as the enhance layer 6a described in FIG. 1, preferably. The enhance layer 33c and the lower second pinned magnetic layer 31c which are formed under the insulating barrier layers 32 and 34, respectively, may be formed to have the same composition and crystal structure as the second pinned magnetic layer 4c described in FIG. 1, preferably.

A method of manufacturing a tunnel type magnetic detection element according to one embodiment will now be described. Please refer the description of the materials of the layers, since the method is described with reference to FIG. 1.

In the embodiment shown in FIG. 1, the base layer 1, the seed layer 2, the anti-ferromagnetic layer 3, the first pinned magnetic layer 4a, the non-magnetic intermediate layer 4b, and the second pinned magnetic layer 4c are continuously formed on the lower shield layer 21 by a sputtering process in a same vacuum space.

Next, in the same vacuum space, on the second pinned magnetic layer 4c, a metal layer or a semiconductor layer is formed by sputtering.

Here, when the insulating barrier layer 5 shown in FIG. 1 is formed of titanium oxide, a titanium layer is formed on the second pinned magnetic layer 4c using a T1 target. Then, the insulating barrier layer 5 which is formed of titanium oxide is formed by oxidizing the titanium layer using natural oxidation, radical oxidation, ion oxidation, plasma oxidation, or the like.

Next, on the insulating barrier layer 5, the enhance layer 6a, the soft magnetic layer 6b, and the protection layer 7 are continuously formed by a sputtering process in the same vacuum space.

In the present method according to one embodiment, the Fe composition ratio of the enhance layer 6a is may be higher than the Fe composition ratio of the second magnetic layer 4c.

In the embodiment, the second pinned magnetic layer 4c may be formed of Co_{100-X}Fe_{X}, and the Fe composition ratio X preferably may lie in the range of from 0 at. % to about 50 at. %. More preferably, the Fe composition ratio X may be be equal to or higher than about 30 at. %, and, even more preferably, the Fe composition ratio X may be equal to or lower than about 20 at. %. As described above, the second pinned magnetic layer 4c may be formed of Co or a CoFe alloy of which the Fe composition ratio X is low, preferably.

In addition, the enhance layer 6a may be formed of Co_{100-Y}Fe_{Y}, and the Fe composition ratio Y of the enhance layer 6a may be in the range of from about 30 at. % to 100 at. %, preferably. More preferably, the Fe composition ratio Y of the enhance layer 6a may be in the range of from about 50 at. % to 100 at. %, and, even more preferably, in the range of from about 70 at. % to 100 at. %. As described above, the enhance layer 6a may be formed of Fe or a CoFe alloy of which the Fe composition ratio Y is high.

By lowering the Fe composition ratio of the second pinned magnetic layer 4c (or configuring the Fe composition ratio to be zero), it may be difficult for the second pinned magnetic layer to be oxidized when the insulating barrier layer 5 is formed, and accordingly, a depth of an oxide layer which is formed on a boundary surface of the second pinned magnetic layer 4c with the insulating barrier layer 5 can be made as thin as possible.

By having the Fe composition ratio Y of the enhance layer 6a, which is formed on the insulating barrier layer 5, higher than that of the second pinned magnetic layer 4c, which is formed under the insulating barrier layer 5, it is thought that oxygen of the oxide layer which is formed on the second pinned magnetic layer 4c is attracted toward the enhance layer 6a and that the amount of the oxygen around the boundary surface of the second pinned magnetic layer 4c with the insulating barrier layer 5 may be decreased. As a result, the spin polarization of the second pinned magnetic layer 4c may be improved. The enhance layer 6a is originally formed of a magnetic material having a high polarization. Since the enhance layer 6a is formed on the insulating barrier layer 5, the effect of the oxidation on the enhance layer 6a is smaller than on the second pinned magnetic layer 4c. Accordingly, the enhance layer 6a can maintain a high spin polarization.

As described above, according to an embodiment of a method of manufacturing a tunnel type magnetic detection element, the spin polarization of both the second magnetic layer 4c and the enhance layer 6a which mainly contribute to the resistance change ratio (ΔR/R) can be improved. Accordingly, it may be possible to manufacture a tunnel type magnetic detection element having a small RA value and a high resistance change ratio (ΔR/R) in a simple process.

In addition, after stacking the layers up to the protection layer 7, a thermal process in a magnetic field is performed. The magnetic field is applied in a height direction (direction Y). As a result, the magnetizations of the first and second pinned magnetic layers 4a and 4c which constitute the pinned magnetic layer can be pinned in a direction parallel to a height direction and in opposite directions from each other.

As shown in FIG. 1, an etching process for forming the stacked layer body T1 into an approximate trapezoid shape of which a width in a track widthwise direction (direction X) gradually decreases upward from the bottom is performed. Thereafter, on both sides of the track widthwise direction (direction X) of the stacked layer body T1, the lower insulating layer 22, the hard bias layer 23, the upper insulating layer 24 are sequentially stacked from the bottom. In addition, on the protection layer 7 and the upper insulating layer 24, the upper shield layer 26 is formed.

In addition, in a manufacturing process of the tunnel type magnetic detection element, thermal processes are performed. The thermal process for fixing or pinning the magnetization of the pinned magnetic layer 4 described above is a representative example of the thermal processes. By performing the aforementioned thermal processes, a crystallization state of the insulating barrier layer can be improved, and lattice matching on a boundary surface of the insulating barrier layer with the magnetic layer which is formed on the insulating barrier layer may also be improved.

As a method of manufacturing a tunnel type magnetic detection element shown in FIG. 2, a method which is similar to the method of manufacturing a tunnel type magnetic detection element shown in FIG. 1 can be used.

The tunnel type magnetic detection element described herein can be used not only in a hard disk device but also as an MRAM (magnetic resistance memory).

A tunnel type magnetic detection element having a structure shown in FIG. 1 is formed. The configuration of a first basic layer of the stacked layer body T1 includes from the bottom a base layer of Ta (80), a seed layer of NiFeCr (50), an anti-ferromagnetic layer of IrMn (70), a pinned magnetic layer including a first pinned magnetic layer of Co_{70 at %}Fe_{30 at %} (14) a non-magnetic intermediate magnetic layer of Ru (8.5), and a second pinned magnetic layer of Co_{90 at. %}Fe_{10 at %}, an insulating barrier layer of Ti—O (14), a free magnetic layer including Co_{100-Y}Fe_{Y} (10) and NiFe (40), and a protection layer of Ta (200). Numbers in parentheses indicate depths of the layers in units of Å. As described above, the enhance layer constituting the free magnetic layer is formed of Co_{100-Y}Fe_{Y}. The Fe composition ratio Y is in units of at. %.

The insulating barrier layer is formed by forming a Ti layer and oxidizing the Ti layer. In the experiment, multiple tunnel type magnetic detection elements of which Fe composition ratios Y of the enhance layers are changed are formed, and the relationship between the Fe composition ratio Y and the RA value and the relationship between the Fe composition ratio Y and the resistance change ratio (ΔR/R) were studied.

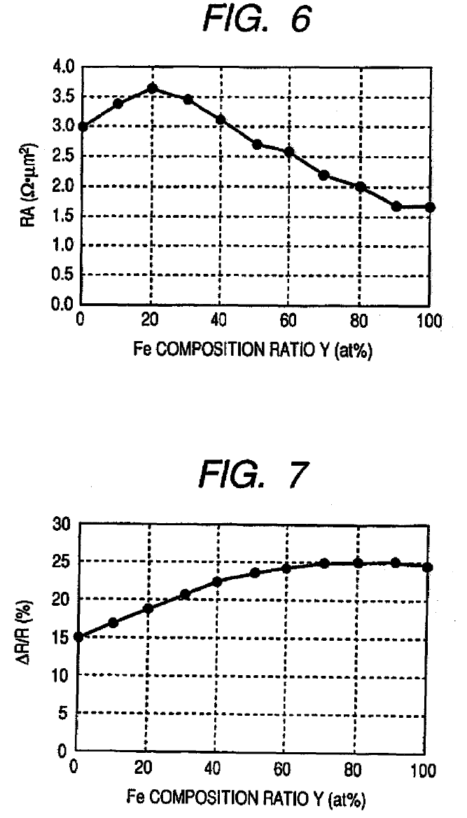

FIG. 6 is a graph showing the relationship between the Fe composition ratio and the RA value. As shown in FIG. 6, it has been found that when the Fe composition ratio Y reaches about 20 at. %, the RA value reaches a maximum value and that as the Fe composition ratio Y is increased far above 20 at. %, the Ra value decreases.

FIG. 7 is a graph showing the relationship between the Fe composition ratio and the resistance change ratio (ΔR/R). As shown in FIG. 7, it has been found that the resistance change ratio (ΔR/R) increases as the Fe composition ratio Y is increased.

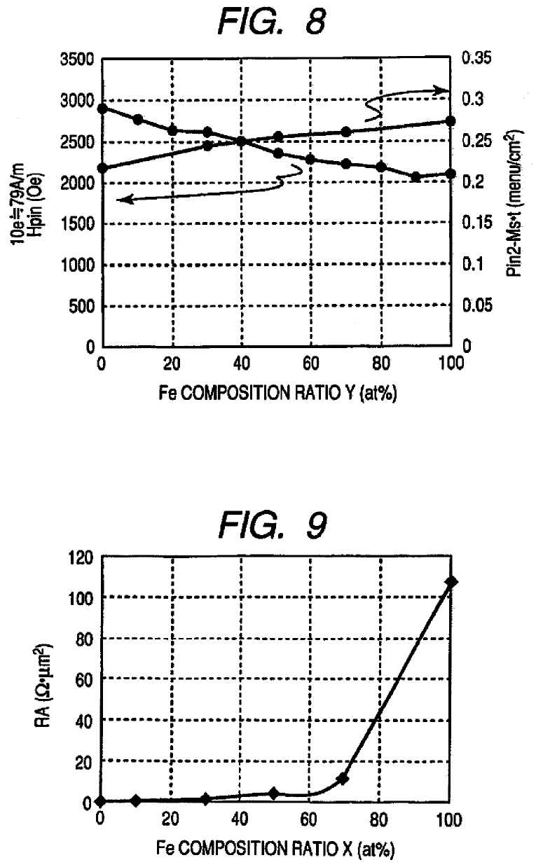

FIG. 8 is a graph showing the Fe composition ratio Y and a bias magnetic field Hpin which applies to the pinned magnetic layer and the relationship between the Fe composition ratio Y and an Ms·t value of the second pinned magnetic layer. The bias magnetic field Hpin is a magnitude of a total magnetic field including an exchange coupled magnetic field Hex which applies between the pinned magnetic layer and the anti-ferromagnetic layer and an anti-ferromagnetic exchange coupled magnetic field (RKKY interaction) which applies between the first and second pinned magnetic layers. Ms is a saturation magnetization of the second pinned magnetic layer, and t is a depth of the second pinned magnetic layer.

Here, the Fe composition ratio Y which is changed in the experiment is the Fe composition ratio of the enhance layer, and the composition (materials and depth) of the pinned magnetic layer is not changed. Accordingly, the bias magnetic field Hpin applied to the pinned magnetic layer or the Ms·t value of the second magnetic layer are not expected to change. However, as shown in FIG. 8, there were in fact changes in the bias magnetic field Hpin of the pinned magnetic layer and the Ms·t value of the second magnetic layer.

From the result of the experiment shown in FIG. 8, it is thought that oxygen around the boundary surface of the second pinned magnetic layer with the insulating barrier layer is attracted more strongly toward the enhance layer and thus the amount of the oxygen of the second pinned magnetic layer around the boundary surface decreases as the Fe composition ratio Y increases above the Fe composition ratio of the second pinned magnetic layer. Accordingly, as the Fe composition ratio Y is increased, the Ms·t value of the second magnetic layer increases and the bias magnetic field Hpin of the pinned magnetic layer decreases.

Next, a tunnel type magnetic detection element having the structure shown in FIG. 1 and the following basic layer configuration of the second basic layer is formed. The configuration of the second basic layer of the stacked layer body T1 shown in FIG. 1 includes from the bottom a base layer of Ta (80), a seed layer of NiFeCr (50), an anti-ferromagnetic layer IrMn (70), a pinned magnetic layer including a first pinned magnetic layer of Co_{70 at. %}Fe_{30 at. %} (14), a non-magnetic intermediate layer of Ru (8.5), and a second pinned magnetic layer of Co_{100-X}Fe_{X}, an insulating barrier layer of Ti—O (14), a free magnetic layer including Co_{50 at. %}Fe_{50 at. %} (10) and NiFe (40), and a protection layer of Ta (200). Numbers in parentheses indicate depths of the layers in units of Å. As described above, the second pinned magnetic layer is formed of Co_{100-Y}Fe_{X}. The Fe composition ratio X is in units of at. %.

In addition, the insulating barrier layer is formed by forming a Ti layer and oxidizing the Ti layer. In the experiment, multiple tunnel type magnetic detection elements of which Fe composition ratios X of the second pinned magnetic layers are changed are formed, and the relationship between the Fe composition ratio X and the RA value and the relationship between the Fe composition ratio X and the resistance change ratio (ΔR/R) were researched.

FIG. 9 is a graph showing the relationship between the Fe composition ratio X and the RA value. As shown in FIG. 9, it has been found that there is a modest increase in the RA value when the Fe composition ratio X increases up to about 50 at. % and that the RA value increases rapidly when the Fe composition ratio exceeds 50 at. %.

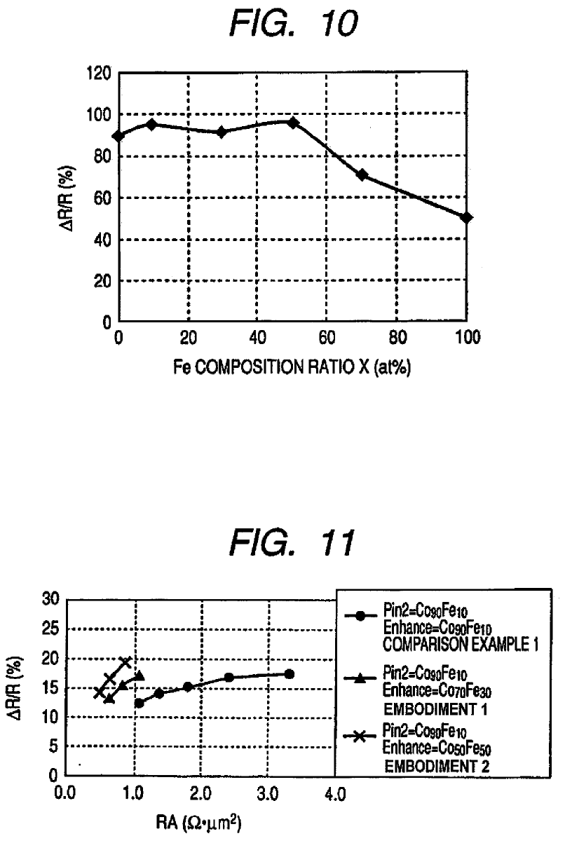

FIG. 10 is a graph showing the relationship between the Fe composition ratio X and the resistance change ratio (ΔR/R). As shown in FIG. 10, it has been found that when the Fe composition ratio X is increased up to about 50 at. %, a high resistance change ratio (ΔR/R) is maintained and that the resistance change ratio ((ΔR/R) decreases when the Fe composition ratio X exceeds 50 at. %.

From the results of the experiments shown in FIGS. 6 to 10, it has been found preferable to have the Fe composition ratio Y of the enhance layer, which is formed on the insulating barrier layer, at a higher level than the Fe composition ratio X of the second pinned magnetic layer to decrease the RA value and increase the resistance change ratio (ΔR/R). As described with reference to FIG. 8, it is assumed that oxygen around the boundary surface of the second pinned magnetic layer, which is formed under the insulating barrier layer, with the insulating barrier layer is attracted toward the enhance layer, which is formed on the insulating barrier layer. Thus, the amount of the oxygen of the second pinned magnetic layer may decrease and, accordingly, the spin polarization of the second pinned magnetic layer may increase. In addition, it is assumed that since it is difficult for the enhance layer, which is formed on the insulating barrier layer, to be oxidized and the enhance layer has an originally high Fe composition ratio to have a high spin polarization, the RA value may decrease and the resistance change ratio (ΔR/R) may increase simultaneously.

In addition, from the results of the experiments shown in FIGS. 6 and 7, when the enhance layer, which is formed on the insulating barrier layer, is formed of Co_{100-Y}Fe_{Y}, it has been found that the Fe composition ratio Y may be preferably in the range of from about 30 at. % to 100 at. %, more preferably in the range of from about 50 at. % to 100 at. %, and even more preferably in the range of from about 70 at. % to 100 at. %. In addition, from the results of the experiments shown in FIGS. 9 and 10, when the second fixed layer, which is formed under the insulating barrier layer, is formed of Co_{100-X}Fe_{X}, it has been found that the Fe composition ratio X may be formed preferably in the range of from 0 at. % to about 50 at. %, and more preferably in the range of from 0 at. % to about 30 at. %.

On the other hand, when a structure different from the basic layer configuration used in the experiments is employed, in which the second pinned magnetic layer is formed on the insulating barrier layer and the enhance layer is formed under the insulating barrier layer, the Fe composition ratio of the second fixed layer may be set to be higher than that of the enhance layer. In other words, it is important to set the Fe composition ratio of a magnetic layer which is formed on the insulating barrier layer to be higher than that of a magnetic layer which is formed under the insulating barrier layer in order to decrease the RA value and increase the resistance change ratio (ΔR/R).

Next, FIG. 11 is a graph showing the relationship between the Ra value and the resistance change ratio (ΔR/R) of each tunnel type magnetic detection element, when the tunnel type magnetic detection element having the first basic layer configuration is used and the second pinned magnetic layer is formed of Co_{90 at. %}Fe_{19 at. %} fixedly, and when the enhance layer is formed of Co_{90 at. %}Fe_{10 at. %} (comparison example 1), Co_{70 at. %}Fe_{30 at. %} (embodiment 1), or Co_{50 at. %}Fe_{50 at. %} (embodiment 2). In addition, the RA value was changed by changing an oxidation time of the Ti layer.

As shown in FIG. 11, it has been found that a higher resistance change ratio (ΔR/R) can be obtained in the range for relatively small RA values in embodiments 1 and 2 than in the comparison example 1.

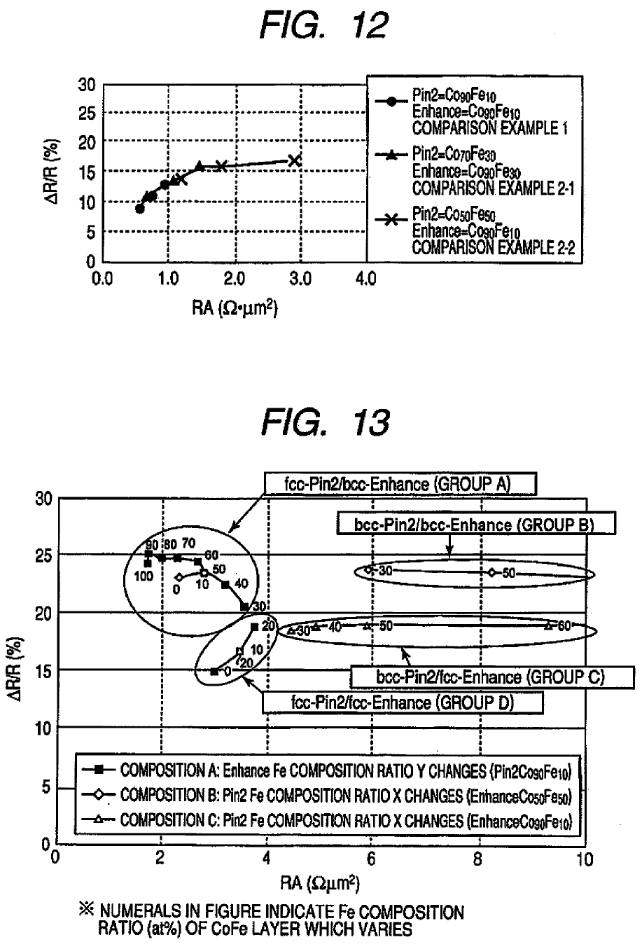

Next, FIG. 12 is a graph showing the relationship between the RA value and the resistance change ratio (ΔR/R) of each tunnel type magnetic detection element, when the tunnel type magnetic detection element having the second basic layer configuration is used (here, the enhance layer is formed of Co_{90 at. %}Fe_{10 at. %} instead of Co_{50 at. %}Fe_{50 at. %}) and the enhance layer is formed of Co_{90at. %}Fe_{10 at. %} fixedly, and when the second magnetic layer is formed of Co_{90 at. %}Fe_{10 at. %} (comparison example 1), Co_{70 at. %}Fe_{30 at. %} (comparison example 2-1), or Co_{50 at. %}Fe_{50 at. %} (comparison result 2-2). In addition, the RA value may be changed by changing an oxidation time of the Ti layer.

As shown in FIG. 12, it has been found that the comparison examples 1, 2-1, and 2-2 are almost on a same curve and that in the comparison examples 1, 2-1, and 2-2, decreasing the RA value together with increasing the resistance change ratio (ΔR/R) may not be done, unlike in the embodiments 1 and 2 shown in FIG. 11.

As described above, it has been found that the RA value may not be decreased and the resistance change ratio (ΔR/R) may not be increased additionally, compared with a case where the Fe composition ratio of the magnetic layer formed on the insulating barrier layer is higher than that of the magnetic layer formed under the insulating barrier layer (embodiment), when the Fe composition ratio of the magnetic layer formed on the insulating barrier layer is the same as that of the magnetic layer formed under the insulating barrier layer (comparison example 1), or when the Fe composition ratio of the magnetic layer formed on the insulating barrier layer is lower than that of the magnetic layer formed under the insulating barrier layer (comparison example 2).

Next, tunnel type magnetic detection elements in which the first basic layer configurations are used, the second pinned magnetic layers are formed of Co_{90 at. %}Fe_{10 at. %} fixedly, and the Fe composition ratios Y of Co_{100-Y}Fe_{Y} of the enhance layers varies from 0 to 100 at. % by 10 at. % are formed, respectively. For each tunnel type magnetic detection element, the relationship between the RA value and the resistance change ratio (ΔR/R) and the crystal structure of the second pinned magnetic layer and the enhance layer are studied (Composition A).

In addition, the relationship between the RA value and the resistance change ratio (ΔR/R) and the crystal structure of the second pinned magnetic layer and enhance layer of each tunnel type magnetic detection element are studied when the second basic layer configurations are used. The enhance layers are formed of Co_{50 at. %}Fe_{50 at. %} fixedly, and the Fe composition ratios X of Co_{100-X}Fe_{X} of the second pinned magnetic layers are set to be 0 at. %, 10 at. %, 30 at. %, and 50 at. %, respectively (Composition B).

In addition, the relationship between the RA value and the resistance change ratio (ΔR/R) and the crystal structure of the second pinned magnetic layer and the enhance layer of each tunnel type magnetic detection element are studied when tunnel type magnetic detection elements in which the second basic layer configurations are used. The enhance layers are formed of Co_{90 at. %}Fe_{10 at. %} fixedly, and the Fe composition ratios X of Co_{100-X}Fe_{X} of the second pinned magnetic layers are set to be 20 at. %, 30 at. %, 40 at. %, 50 at. %, and 60 at. %, respectively (Composition C).

As shown in FIG. 13, a tunnel type magnetic detection element included in the group A includes the second pinned magnetic layer (magnetic layer which is arranged under the insulating barrier layer) having a face centered cubic (fcc) structure and the enhance layer (magnetic layer which is arranged on the insulating barrier layer) having a body centered cubic (bcc) structure. A tunnel type magnetic detection element included in the group B includes the second pinned magnetic layer (magnetic layer which is arranged under the insulating barrier layer) having a body centered cubic (bcc) structure and the enhance layer (magnetic layer which is arranged on the insulating barrier layer) having a body centered cubic (bcc) structure. A tunnel type magnetic detection element included in the group C includes the second pinned magnetic layer (magnetic layer which is arranged under the insulating barrier layer) having a body centered cubic (bcc) structure and the enhance layer (magnetic layer which is arranged on the insulating barrier layer) having a face centered cubic (fcc) structure. A tunnel type magnetic detection element included in the group D includes the second pinned magnetic layer (magnetic layer which is arranged under the insulating barrier layer) having a face centered cubic (fcc) structure and the enhance layer (the magnetic layer which is arranged on the insulating barrier layer) having a face centered cubic (fcc) structure.

As shown in FIG. 13, it has been found that a group in which the RA value can be decreased and the resistance change ratio (ΔR/R) can be increased simultaneously is group A. In other words, when the second pinned magnetic layer (magnetic layer which is arranged under the insulating barrier layer) is configured to be a face centered cubic (fcc) structure and the enhance layer (magnetic layer which is arranged on the insulating barrier layer) is configured to be a body centered cubic (bcc) structure, it has been found that the RA value can be decreased and the resistance change ratio (ΔR/R) can be increased simultaneously, more effectively.

From the result of the experiment shown in FIG. 13, it has been found that the Fe composition ratio of a CoFe alloy may be preferably in the range of from 0 to about 20 at. % so as to acquire a face centered cubic (fcc) structure. From the results of the experiments shown in FIGS. 9 and 10, although the Fe composition ratio of the second pinned magnetic layer (magnetic layer which is formed under the insulating barrier layer) may be from 0 to about 50 at. % and preferably equal to or lower than about 30 at. %, it has been found that the Fe composition ratio of the second pinned magnetic layer may be equal to or lower than about 20 at. % more preferably and that the second pinned magnetic layer may have a face centered cubic structure in this case.

In addition, from the result of the experiment shown in FIG. 13, although it has been found that the Fe composition ratio of a CoFe alloy may be preferably in the range of from about 30 to 100 at. % so as to acquire a body centered cubic (bcc) structure, from the results of the experiments shown in FIGS. 6 and 7, the Fe composition ratio of the enhance layer (magnetic layer which is formed on the insulating barrier layer) may be from about 30 to 100 at. %, may be equal to or higher than 50 at. % preferably, and more preferably, may be equal to or higher than 70 at. % and that the second pinned magnetic layer has a bcc structure within the composition ratio described above.

Next, the resistance change ratio (ΔR/R) and magnetostriction of each tunnel type magnetic detection element which uses the first basic layer configuration and has a following configuration of the free magnetic layer are obtained.

The structure of the free magnetic layer includes an enhance layer of Co_{90 at. %}Fe_{10 at. %}, a soft magnetic layer of Ni_{81.5 at. %}Fe_{18.5%} (comparison example 1), an enhance layer of Co_{50 at. %}Fe_{50 at. %} and a soft magnetic layer of Ni_{81.5 at. %}Fe_{18.5 at. %} (embodiment 1), or an enhance layer of Co_{50 at. %}Fe_{50 at. %} and a soft magnetic layer of Ni_{86 at. %}Fe_{14 at. %} (embodiment 2).

In the comparison example 3, the Fe composition ratios of the enhance layer (magnetic layer which is formed on the insulating barrier layer) and the second pinned magnetic layer (magnetic layer which is formed under the insulating barrier layer) are the same. On the other hand, in the embodiments 3 and 4, the Fe composition ratio of the enhance layer (magnetic layer which is formed on the insulating harrier layer) is higher than that of the second pinned magnetic layer (magnetic layer which is formed under the insulating barrier layer). In addition, the Ni composition ratio of the soft magnetic layer in the embodiment 4 is higher than the Ni composition ratio in the embodiment 3.

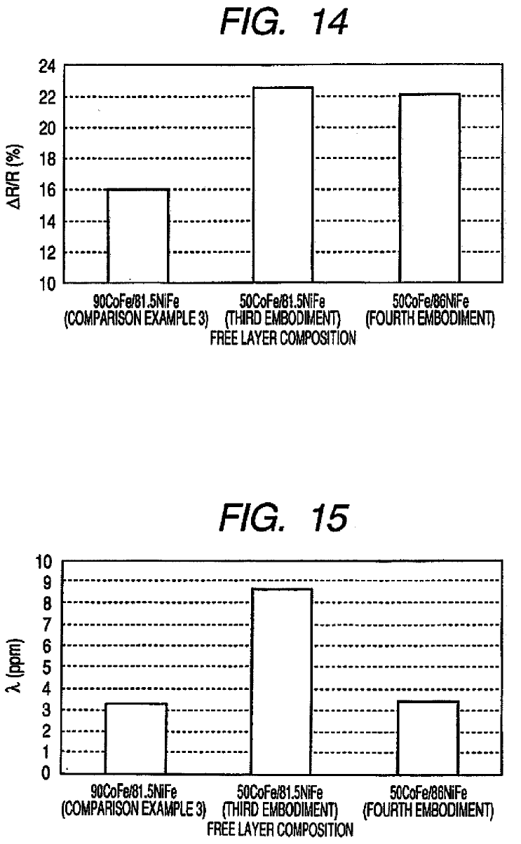

As shown in FIG. 14, it has been found that the resistance change ratio (ΔR/R) in embodiment 3 or 4 is greater than that in the comparison example 3. This is a same trend as that of the experiments described above.

In addition, it has been found that, as shown in FIG. 15, the magnetostriction of the free magnetic layer has a small value in the comparison example 3 or the embodiment 4 and a larger value in the embodiment 3.

It has found that the composition of the soft magnetic layer needs to be adjusted so as to increase the resistance change ratio (ΔR/R) and decrease the magnetostriction of the free magnetic layer, as shown in embodiment 4. In a CoFe alloy, when the Fe composition ratio is increased, the CoFe alloy has a large positive magnetostriction. The enhance layer of the embodiment has a large positive magnetostriction. Accordingly, it has found that the absolute value of the magnetostriction of the free magnetic layer can be decreased by increasing the Ni composition ratio to make the magnetostriction of the soft magnetic layer negative when the soft magnetic layer is formed of a NiFe alloy as in the embodiment 4. In more details, when the Ni composition ratio is in the range higher than about 81.5 at. % and equal to or lower than 100 at. %, the soft magnetic layer may have a negative magnetostriction, and accordingly, the absolute value of the magnetostriction of the free magnetic layer can be decreased appropriately.

In addition, in the magnetostriction experiment of the free magnetic layer, a configuration in which the free magnetic layer is arranged on the insulating barrier layer is used. When the free magnetic layer is formed under the insulating barrier layer, the Fe composition ratio of the enhance layer constituting the free magnetic layer is originally set to be low as a general case, so it is needless to adjust the magnetostriction of the free magnetic layer by changing the composition of the soft magnetic layer.

The invention is not limited to the above-described embodiments but various changes and modifications thereof can be made. For example, the material or dimension of each layer in the present embodiment is only illustrative, but is not limited thereto. Therefore, modifications can be properly made without departing from the subject matter or spirit of the invention.

1. A tunnel type magnetic detection element comprising:
a lower magnetic layer, an insulating barrier layer, and an upper magnetic layer sequentially stacked from below,
wherein one of the magnetic layers forms at least a portion of a pinned magnetic layer having a fixed magnetization and the other magnetic layer forms at least a portion of a free magnetic layer having a magnetization that varies in accordance with an external magnetic field,
wherein the insulating barrier layer is formed of an oxide, and
wherein X, a composition ratio of Fe in the upper magnetic layer, is higher than Y, a composition ratio of Fe in the lower magnetic layer.

2. The tunnel type magnetic detection element according to claim 1, wherein the insulating barrier layer is formed of titanium oxide.

3. The tunnel type magnetic detection element according to claim 1, wherein the lower magnetic layer is formed of Co_{100-X}Fe_{X}, X having units of at. %, and the upper magnetic layer is formed of Co_{100-Y}Fe_{Y}, Y having units of at. %.

4. The tunnel type magnetic detection element according to claim 3, wherein X is in the range of from 0 at. % to about 50 at. %.

5. The tunnel type magnetic detection element 5 according to claim 4, wherein X is in the range of from 0 at. % to about 30 at. %.

6. The tunnel type magnetic detection element according to claim 3, wherein Y is in the range of from about 30 at. % to 100 at. %.

7. The tunnel type magnetic detection element according to claim 6, wherein Y is in the range of from about 50 at. % to 100 at. %.

8. The tunnel type magnetic detection element according to claim 1,
wherein the pinned magnetic layer is formed under the insulating barrier layer, the pinned magnetic layer has a stacked layer ferri-structure in which a first pinned magnetic layer, a non-magnetic intermediate layer, and a second pinned magnetic layer are sequentially stacked from below and the second pinned magnetic layer contacts a bottom surface of the insulating harrier layer,
wherein the free magnetic layer is disposed on the insulating barrier layer and the free magnetic layer comprises a stacked layer structure including an enhance layer disposed on a top surface of the insulating barrier layer and a soft magnetic layer disposed on the enhance layer, and
wherein at least a part of the second pinned magnetic layer is disposed in the lower magnetic layer and at least a part of the enhance layer is disposed in the upper magnetic layer.

9. The tunnel type magnetic detection element according to claim 8, wherein the soft magnetic layer comprises a magnetostriction control region having a magnetostriction with a sign opposite to a magnetostriction of the upper magnetic layer.

10. The tunnel type magnetic detection element according to claim 9, wherein the upper magnetic layer is formed of a CoFe alloy, the magnetostriction control region is formed of Ni_{Z}Fe_{100-Z}, and Z, a composition ratio of Ni, is greater than about 81.5 at. % and equal to or lower than 100 at. %.

11. The tunnel type magnetic detection element according to claim 1,
wherein the free magnetic layer is formed under the insulating barrier layer and has a structure in which a soft magnetic layer and an enhance layer are sequentially stacked from below and the enhance layer contacts a bottom surface of the insulating barrier layer, and
wherein the pinned magnetic layer is formed on the insulating barrier layer, the pinned magnetic layer includes a stacked layer ferri-structure in which a second pinned magnetic layer contacting the top surface of the insulating barrier layer, a non-magnetic intermediate layer, and a first pinned magnetic layer are stacked sequentially from below, at least a part of the enhance layer is disposed in the lower magnetic layer, and at least a part of the second pinned magnetic layer is disposed in the upper magnetic layer.

12. A method of manufacturing a tunnel type magnetic detection element, the method comprising the steps of:
(a) forming a lower magnetic layer;
(b) forming a metal layer or a semiconductor layer on the lower magnetic layer;
(c) forming an insulating barrier layer by oxidizing the metal layer or the semiconductor layer; and
(d) forming an upper magnetic layer on the insulating barrier layer out of a magnetic material wherein X, a composition ratio of Fe in the magnetic material of the upper magnetic layer, is higher than Y, a composition ratio of Fe in a magnetic material of the lower magnetic layer.

13. The method according to claim 12, wherein the metal layer is a titanium layer and the insulating barrier layer is formed of titanium oxide.

14. The method according to claim 12,
wherein the lower magnetic layer comprises Co_{100-X}Fe_{X}, X being in the range of from 0 at. % to about 50 at. %.

15. The method according to claim 14, wherein X is in the range of from 0 at. % to about 30 at. %.

16. The method according to claim 12, wherein the upper magnetic layer comprises Co_{100-Y}Fe_{Y}, Y being in the range of from about 30 at. % to 100 at. %.

17. The method according to claim 16, wherein Y is in the range of from about 50 at. % to 100 at. %.
